(19) United States
(12) Patent Application Publication
(10) Pub. No.: US 2003/0218765 A1
(43) Pub. Date: Nov. 27, 2003

(54) Apparatus for controlling launch of application and method

(76) Inventors: Tsutomu Ohishi, Fukuoka (JP); Kunihiro Akiyoshi, Fukuoka (JP); Hiroyuki Tanaka, Fukuoka (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/422,759

(22) Filed: Apr. 25, 2003

(30) Foreign Application Priority Data
Apr. 26, 2002 (JP) 2002-127079
Apr. 24, 2003 (JP) 2003-120250
Apr. 24, 2003 (JP) 2003-120251

(51) Int. Cl. G06F 15/00; B41F 1/00; G06K 1/00

(52) U.S. Cl. 358/1.13; 358/1.15

(57) ABSTRACT

An apparatus for controlling launch of an application is provided, in which the apparatus includes resources used for executing an application, and the apparatus includes: a part for obtaining resource status information indicating status of resources of the apparatus when the application is launched; and a part for sending a message on launch determination to the application by referring to the resource status information and resource use information on resources to be used by the application.

### BACKGROUND OF THE INVENTION

1. Field of the Invention

The present invention relates to techniques for controlling launch of an application according to resources used by the application.

2. Description of the Related Art

Recently, an image forming apparatus (to be referred to as a compound machine hereinafter) that includes functions of a printer, a copier, a facsimile, a scanner and the like in a cabinet is generally known. The compound machine includes a display part, a printing part and an image pickup part and the like in a cabinet. In the compound machine, three pieces of software corresponding to the printer, copier and facsimile respectively are provided, so that the compound machine functions as the printer, the copier, the scanner and the facsimile respectively by switching the software.

In such a conventional compound machine, applications for printer, copier, facsimile and scanner are executed within limited resources such as a memory area that is provided for each application. In other words, in the conventional compound machine, since the applications are provided with necessary resources, it can not be considered that an application program can not be launched due to lack of a resource.

Since the conventional compound machine is provided with each software for the printer, the copier, the scanner and the facsimile individually, much time is required for developing the software. Therefore, the applicant has developed an image forming apparatus (compound machine) including hardware resources, a plurality of applications, and a platform including various control services provided between the applications and the hardware resources. The hardware resources are used for an image forming process in a display part, a printing part and an image pickup part The applications perform processes intrinsic for user services of printer, copier and facsimile and the like. The platform includes various control services performing management of hardware resource necessary for at least two applications commonly, execution control of the applications and image forming processes when a user service is executed.

Since the image forming apparatus is provided with the control services, separately from applications, that provide services necessary for at least two applications commonly, the size of the application is smaller than that for the conventional compound machine, and launch and end of the application are performed frequently.

Therefore, usage of resources such as memories mounted on the compound machine frequently change, so that there occurs a case where all applications can not be launched. When an application is launched in such a condition where resources are not enough, the application may terminate incorrectly, so that there occurs a problem in that the operation of the compound machine become unstable.

According to such a new compound machine, the applications and the control services are provided separately. Thus, after the compound machine is shipped, users or third party venders can develop new applications to install on the compound machine. Therefore, different from the conventional compound machine, many applications such as a new application developed by the user or the third party can be installed on the new compound machine in addition to applications for copier printer, scanner and facsimile that are included at the time of shipment. Each of the pre-installed applications for the copier, printer, facsimile and scanner is developed in consideration of limited resources. On the other hand, it can be considered that the new application may be developed without consideration of the limited resources. Therefore, there occurs a problem in that there is a high probability that the compound machine becomes unstable when the new application is launched in limited resources. This problem is a new problem that is not a problem for the conventional compound machine.

### SUMMARY OF THE INVENTION

An object of the present invention is to provide a technique to obtain information of resources used by an application to be executed in an apparatus. Another object of the present invention is to provide a technique to determine whether an application can be launched on the basis of the information of resources.

The above object can be achieved by an apparatus including resources used for executing an application including:

a part for obtaining resource status information indicating status of resources of the apparatus when the application is launched; and

a part for sending a message on launch determination to the application by referring to the resource status information and resource use information on resources to be used by the application.

According to this invention, since the message is sent to the application on the basis of the resource status information and the resource use information, the application can determine whether to continue launch of the application. Therefore, problems that may occur if the application is executed while a resource used by the application lacks can be avoided, so that stability of the apparatus can be improved.

The above object can be also achieved by an apparatus including resources used for executing an application including:

an obtaining part for obtaining resource information on resources used by the application while the application is executed, and storing the resource information in a storage.

According to this invention, for example, accurate information for launch determination for the application can be obtained.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram of a compound machine according to the first embodiment of the present invention;

FIG. 2 is a block diagram of another example of a compound machine according to the first embodiment of the present invention;

FIG. 3 shows a configuration of the VAS 140 of the compound machine according to the first embodiment;

FIG. 4 is a figure for explaining an example of information in the resource use information file 201 stored in the HD 200;

FIG. 5 shows an example of the proc structure 211 which is referred to by the resource use information obtaining thread 141;

FIG. 6 is a flowchart showing a process procedure for application registration, and determination of application launch times;

FIG. 7 is a flowchart indicating a process procedure for the resource use information obtaining thread 141 to obtain the resource use information;

FIG. 8 is a flowchart showing a process procedure, by the application launch determining thread 142, for determining whether the application can be launched;

FIG. 9 shows an example of the application management file;

FIG. 10 shows a configuration example of the NV-RAM and the HD for new applications such as the applications 117 and 118;

FIG. 11 is a flowchart showing processes performed by the VAS 140 at the time when the application is launched according to the second embodiment;

FIG. 12 shows an operation of the application that receives the resource evaluation result message;

FIG. 13 shows an example of an application launch termination procedure;

FIG. 14 shows a flowchart showing a procedure for obtaining system configuration information according to the second embodiment;

FIG. 15 shows an example of a system configuration information structure in the compound machine of the second embodiment;

FIG. 16 is a flowchart showing a procedure for obtaining current resource information in the compound machine of the second embodiment;

FIG. 17 is a block diagram showing a configuration of the compound machine 800 of the fourth embodiment;

FIG. 18 is a block diagram showing another configuration of the compound machine 800 of the fourth embodiment;

FIG. 19 shows the configuration of the VASes 841-848 of the compound machine 800 according to the fourth embodiment;

FIGS. 20A-20C show configuration examples of the VAS.

### DETAILED DESCRIPTION OF THE PREFERRED EMBODIMENTS

In the following, an image forming apparatus of an embodiment will be described.

(First Embodiment)

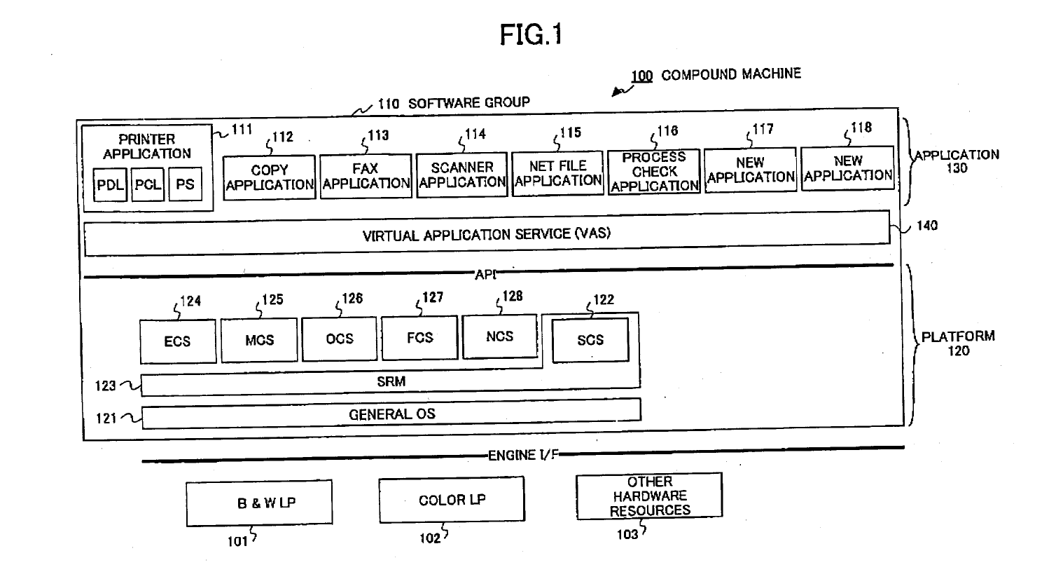

FIG. 1 is a block diagram of an image forming apparatus (to be referred to as a compound machine hereinafter) according to the first embodiment of the present invention. As shown in FIG. 1, the compound machine 100 includes hardware resources and a software group 110. The hardware resources include a black and white line printer (B&W LP) 101, a color line printer 102, and hardware resources 103 such as a scanner, a facsimile, a hard disk, memory (RAM, NV-RAM, ROM and the like) and a network interface. The software group 110 includes a platform 120, applications 130 and a virtual application service 140 (to be referred to as VAS hereinafter).

The VAS 140 is provided between the applications 130 and the platform 120. The VAS 140 obtains usage of resources used by each application when each application is initially launched. Then, VAS 140 generates a resource use information in a hard disk (HD). The obtained resources include text memory area size, heap area size and stack area size that are kept in a memory. The text memory area is a memory area in which the program of each application is loaded. The heap area is a memory area that is allocated to each application dynamically. The stack area is an area allocated for storing arguments and the like when an application is executed or an application calls an inside module.

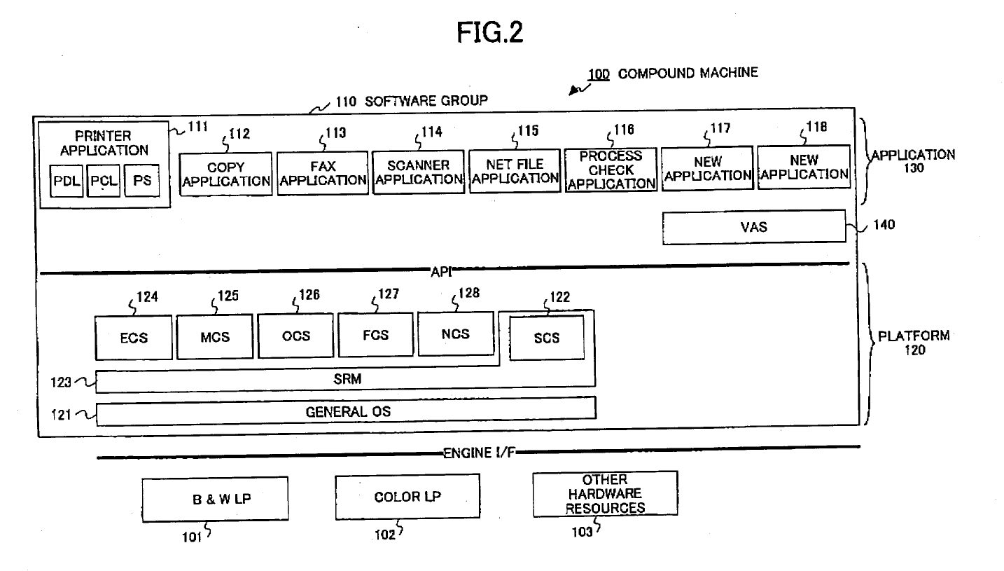

In addition, when an application is launched for the second time or later, the VAS 140 obtains amounts of each resource necessary for the application from a resource use information file and obtains actual remaining amounts of the resource in the compound machine. Then, the VAS 140 compares between both amounts so as to determine whether the application can be launched or not. More particularly, if a remaining amount of a resource is less than an amount necessary for the application for the resource, the VAS sends a launch stop message to the application. As shown in FIG. 2, the VAS 140 may be provided only for new applications.

The platform 120 includes control services for interpreting a process request from an application to issue an acquiring request for the hardware resources, a system resource manager (SRM) 123 for managing one or more hardware resources and arbitrating the acquiring requests from the control service, and a general-purpose OS 121.

The control services include a system control service (SCS) 122 formed by a plurality of service modules, an engine control service (ECS) 124, a memory control service (MCS) 125, a fax control service (FCS) 127, and a network control service (NCS) 128. In addition, the platform 120 has application program interfaces (API) that can receive process requests from the applications 130 by predetermined functions.

The general purpose OS 121 is a general purpose operating system such as UNIX, and can execute each piece of software of the platform 120 and the applications 130 concurrently as a process.

The process of the SRM 123 is for performing control of the system and performing management of resources with the SCS 122. The process of the SRM 123 performs arbitration and execution control for requests from the upper layer that uses hardware resources including engines such as the scanner part and the printer part, a memory, a HDD file, a host I/Os (Centronics I/F, network I/F IEEE1394 I/F, RS232C I/F and the like).

Specifically, the SRM 123 determines whether the requested hardware resource is available (whether it is not used by another request), and, when the requested hardware resource is available, notifies the upper layer that the requested hardware resource is available. In addition, the SRM 123 performs scheduling for using hardware resources for the requests from the upper layer, and directly performs processes corresponding to the requests (for example, paper transfer and image forming by a printer engine, allocating memory area, file generation and the like).

The process of the SCS 122 performs application management, control of the operation part, display of system screen, LED display, resource management, and interrupt application control.

The process of the ECS 124 controls engines of hardware resources including the white and black line printer (B&W LP) 101, the color line printer (Color LP) 102, the scanner, and the facsimile and the like. The process of the MCS 125 obtains and releases an area of the image memory, uses the hard disk apparatus (HDD), and compresses and expands image data.

The process of the FCS 127 provides APIs for sending and receiving of facsimile from each application layer of the system controller by using PSTN/ISDN network, registering/referring of various kinds of facsimile data managed by BKM (backup SRAM), facsimile reading, facsimile receiving and printing, and mixed sending and receiving.

The NCS 128 is a process for providing services commonly used for applications that need network I/O. The NCS 128 distributes data received from the network by a protocol to a corresponding application, and acts as mediation between the application and the network when sending data to the network. More specifically, the process of the NCS 128 includes server daemon such as ftpd, httpd, lpd, snmpd, telnetd, smtpd, and client function of the protocol.

The process of the OCS 126 controls an operation panel that is a means for transferring information between the operator (user) and control parts of the machine. In the compound machine 100 of the embodiment, the OCS 126 includes an OCS process part and an OCS function library part. The OCS process part obtains an key event, which indicates that the key is pushed, from the operation panel, and sends a key event function corresponding to the key event to the SCS 122. The OCS function library registers drawing functions and other functions for controlling the operation panel, in which the drawing functions are used for outputting various images on the operation panel on the basis of a request from an application that has control right or from the control service. when the application is developed, functions in the OCS function library is linked to an object program that is generated by compiling a source code file of the application, so that an executable file of the application is generated.

The application 130 includes a printer application 111 that is an application for a printer having page description language (PDL) and PCL and post script (PS), a copy application 112, a fax application 113 that is an application for facsimile, a scanner application 114 that is an application for an scanner, a network file application 115 and a process check application 116. When each of these application is launched, the application sends an application registering request message with a process ID of its process to the VAS 140. The VAS 140 that receives the application registering request message performs registration processing for the launched application. As to the configuration shown in FIG. 2, an application to which VAS 140 is not provided sends the application registering request message to the SCS 122.

Interprocess communication is performed between a process of the application 130 and a process of the control service, in which a function is called, a returned value is sent, and a message is sent and received. By using the interprocess communication, user services for image forming processes such as copying, printing, scanning, and sending facsimile are realized.

As mentioned above, the compound machine 100 of the first embodiment includes a plurality of applications 130 and a plurality of control services, and each of those operates as a process. In each process, one or more threads are generated and the threads are executed in parallel. The control services provide common services to the applications 130. User services on image formation such as copying, printing, scanning and sending facsimile are provided while the processes are executed in parallel, the threads are executed in parallel, and interprocess communication is performed. A third party vendor can develop applications 117, 118 for the compound machine 100, and can executes the application in an application layer on the control service layer in the compound machine 100. FIG. 1 shows an example including new applications 117 and 118.

In the compound machine of the first embodiment, although processes of applications 130 and processes of control services operate, the application and the control service can be a single process. An application in the applications 130 can be added or deleted one by one.

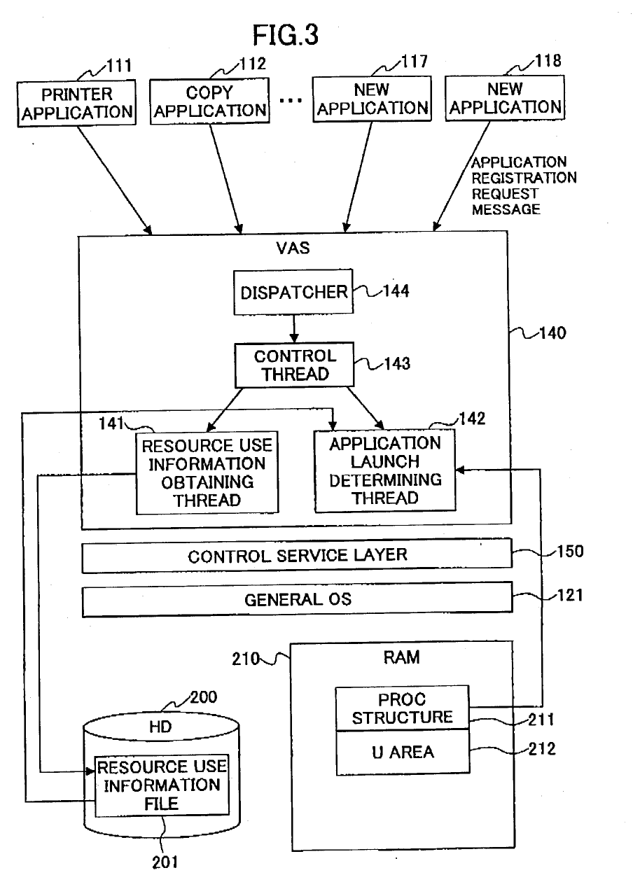

FIG. 3 shows a configuration of the VAS 140 of the compound machine according to the first embodiment. In addition, FIG. 3 shows relationships among the VAS 140, each application, the control service layer 150 and the general OS 121. In FIG. 3, as an example of the applications 130, the printer application 111, the copy application 112, the new applications 117 and 118 are shown.

In the process of the VAS 140, a dispatcher 144, a control thread 143, a resource use information obtaining thread 141, and an application launch determining thread 142 are operating.

The dispatcher 144 monitors receiving of message from the applications 130 and the control services. According to a received message, the dispatcher 144 sends a process request to the control thread 143, the resource use information obtaining thread 141, and the application launch determining thread 142. In the compound machine 100 of the first embodiment, when the dispatcher 144 receives the application registering request message from an application that is to be launched, the dispatcher 144 sends the received application registering request message to the control thread 143.

The control thread 143 receives the application registering request message from the dispatcher 144 so as to perform application registering process. In the application registering process, the control thread 143 generates an application registering table (not shown in figures) in the RAM 210, and registers an application ID that is an identifier of the application sending the application registering request message in the application registering table.

In addition, the control thread 143 checks whether resource use information is stored for the application that sent the application registering request by referring to the resource use information file 201 stored in the HD 200, so that the control thread 143 determines whether the launch of the application is the first launch or the second or more launch. If the launch is the first time, the control thread 143 sends a request for obtaining resource use information with an application ID and the process ID of the application to the resource use information obtaining thread 141. If the launch is for the second time or later, the control thread 143 sends an application launch determining process request with the application ID and the process ID of the application to the application launch determining thread 142.

When the resource use information obtaining thread 141 receives the process request from the control thread 143, the thread 141 obtains the text memory area size, the heap area size, the stack area size, and CPU occupation time used by the application by referring to a proc structure 211 (or u area 212) in the RAM 210 managed by the general OS 121, so that the thread 141 generates the resource use information file 201 in the hard disk. Resource use information is stored as a record for each application. The CPU occupation time is, for example, latest CPU occupation time.

The program of the VAS 140 is provided as a whole or a part of a software development kit (SDK) and the like in a recording medium such as a CD-ROM or FD (flexible disk). In addition, the program of the VAS 140 is provided as an executable file or an installable file. In addition, the program file of the VAS 140 can be provided such that the program can be obtained via a network An application program to be installed in the compound machine can be also provided by storing in an recording medium such as the CD-ROM of FD (flexible disk). In addition, the application program can be provided such that the program can be obtained via a network.

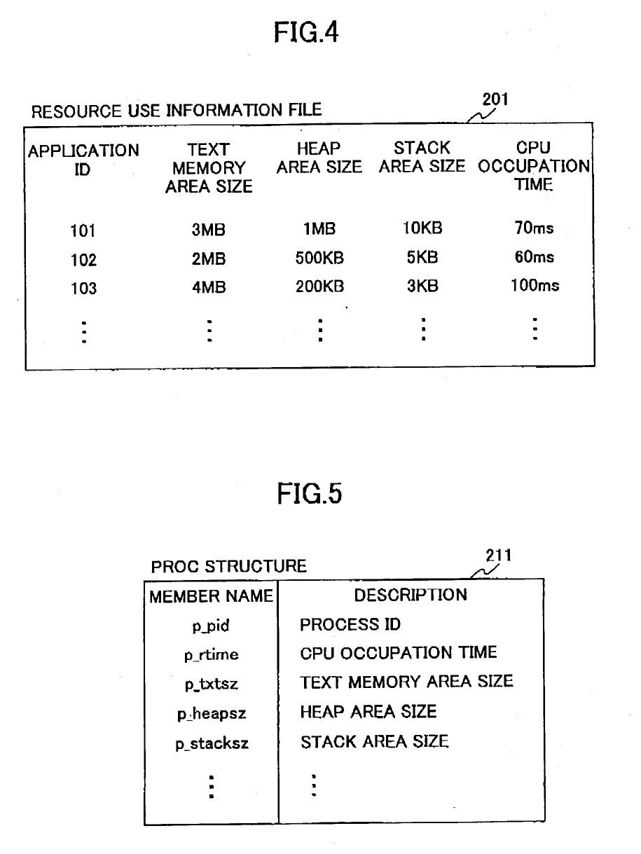

FIG. 4 is a figure for explaining an example of information in the resource use information file 201 stored in the HD 200. As shown in FIG. 4, resource use information file 201 includes a text memory size, a heap size, a stack size and CPU occupation time for each application ID.

FIG. 5 shows an example of the proc structure 211 which is referred to by the resource use information obtaining thread 141. As shown in FIG. 5, the proc structure 211 includes process ID (p_pid), CPU occupation time, text memory size, heap memory size, stack size for each process. The proc structure 211 is updated by the general OS 121 when the process is executed, the process ends, and status of the process changes. Each piece of information in the proc structure 211 can be obtained by the VAS 140 by using system call from the VAS 140.

When the launch of the application is for the second time or later, the application launch determining thread 142 obtains amounts of each resource necessary for the application that requested application registration. The application launch determining thread obtains remaining capacity of the text memory area, remaining capacity of the heap area, remaining capacity of the stack area by referring to the proc structure 211 by using system call of the general OS 121 or by using service function call provided by the control services. The application launch determining thread 142 compares between the necessary resources and the remaining resources so as to determine whether the application can be launched or not. In addition, the application launch determining thread 142 obtains CPU operating ratio by the system call or the service function call.

The application launch determining thread 142 determines the application can be launched or not according to whether the CPU operating ratio exceeds a predetermined value and whether the CPU occupation time exceeds a predetermined time. The relationship between the CPU occupation time and the CPU operating ratio for determining whether the application can be launched is predetermined.

When the application launch determining thread 142 determines that the application can be launched, the application launch determining thread 142 sends a launch available message to the application. when the application launch determining thread 142 determines that the application should not be launched, the application launch determining thread 142 sends a launch end request message to the application.

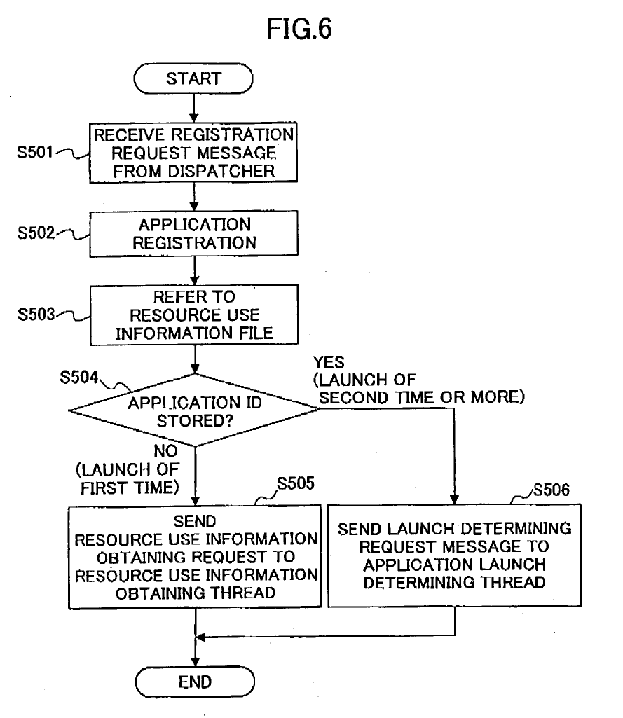

Next, the application launch determining process by the VAS 140 of the thus structured compound machine 100 will be described. FIG. 6 is a flowchart showing a process procedure for application registration, and determination of application launch times, in which the process is performed by the control thread 143 of the VAS 140.

When the dispatcher 144 receives the application registration request message from the application to be launched, the dispatcher 144 passes the application registration request message to the control thread 143 with the process ID of the application. When the control thread 143 receives the application registration request message and the process ID from the dispatcher 144 in step S501, the control thread 143 determines an application ID for identifying the application, so that the control thread 143 performs application registration by recording the application ID to the application registration table in step S502. The application ID is predetermined for the existing applications such as the copy application 112, the printer application 111 and the like. The VAS 140 includes the predetermined application IDs. As to the new applications 117, 118 developed by the third party vendor, the ID is determined when the application is launched at the first time as mentioned above.

The control thread 143 refers to the resource use information file 201 stored in the ED 200 in step S503, so that control thread 143 checks whether resource use information for the registered application is included in the resource use information file 201. Accordingly, the control thread 143 determines whether the launch of the application is the first time launch for the application or second time launch or more in step S504.

When the resource use information for the application is not stored in the resource use information file 201 (No in step S504), the control thread 143 determines that the launch is the first time launch, so that the control thread 143 sends a resource use information obtaining request with the application ID and the process ID of the application to the resource use information obtaining thread 141 in order to obtain resource use information for resources used by the application in step S505.

When the resource use information for the application is stored in the resource use information file 201 (Yes in step S504), the control thread 143 determines that the launch of the application is the second time launch or more, so that the control thread 143 sends an application launch determining request message with the application ID and the process ID of the application in step S506 in order to determine whether the application can be launched.

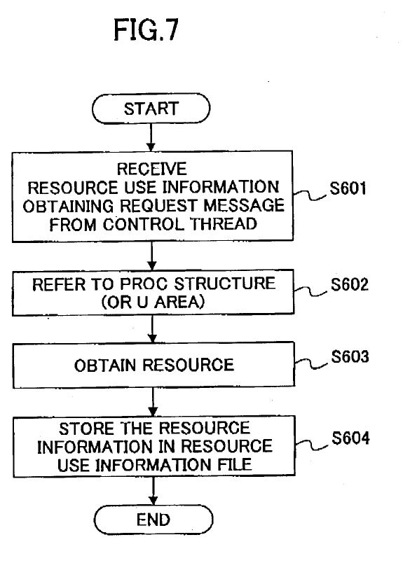

FIG. 7 is a flowchart indicating a process procedure for the resource use information obtaining thread 141 to obtain the resource use information. The resource use information obtaining thread 141 performs the following processes when the application is launched for the first time.

When the resource use information obtaining thread 141 receives the application ID, the process ID and the resource use information obtaining request message from the control thread 143 in step S601, the thread 141 searches the proc structure 211 for the position of a block of the process ID of the application in step S602. Then, the thread 141 obtains resource use information of the text memory area size, the heap area size, the stack area size and CPU occupation time from the searched block of the process ID in step S603. The thread 141 records the obtained resource use information to the resource use information file 201 with the application ID in step S604. Accordingly, information of recourses necessary for the application is stored in the resource use information file 201.

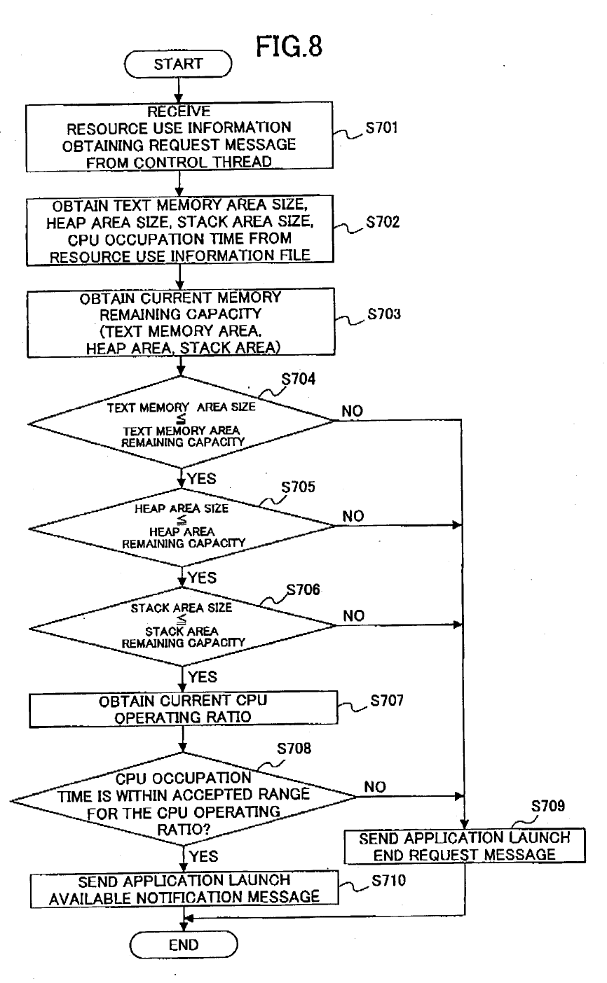

FIG. 8 is a flowchart showing a process procedure, by the application launch determining thread 142, for determining whether the application can be launched. The application launch determining thread 142 executes the following process when the launch of the application is for the second time or more. when the application launch determining thread 142 receives the application ID, the process ID and the application launch determining request message from the control thread 143 in step S701, the application launch determining thread 142 searches the resource use information file 201 for a record of resource use information corresponding to the application ID so as to obtain the text memory area size, the heap area size, the stack area size and the CPU occupation time in step S702, Next, the application launch determining thread 142 obtains current memory resource usage from the proc structure by using the system call or the function call so as to obtain remaining capacities of the resources in step S703. Accordingly, remaining amounts for the text memory area, the heap area, and the stack area can be obtained.

Then, the application launch determining thread 142 compares the text memory area size necessary for the launch of the application with the remaining amount of the text memory area in step S704. As a result of the comparison, if the text memory area size is larger than the remaining amount of the text memory area (No in step S704), the application launch determining thread 142 determines that the application cannot be executed, and sends an application launch end request message to the application in step S709 If the text memory area size is no more than the remaining amount of the text memory area (Yes in step S704), the application launch determining thread 142 determines that the text memory area necessary for execution of the application can be kept. Next, the application launch determining thread 142 compares the heap area size necessary for the launch of the application with the remaining amount of the heap area in step S705. As a result of the comparison, if the heap area size is larger than the remaining amount of the heap area (No in step S705), the application launch determining thread 142 determines that the application cannot be executed, and sends an application launch end request message to the application in step 5709.

If the heap area size is no more than the remaining amount of the heap area (Yes in step S705), the application launch determining thread 142 determines that the heap area necessary for execution of the application can be kept. Next, the application launch determining thread 142 compares the stack area size necessary for the launch of the application with the remaining amount of the stack area in step S706. As a result of the comparison, if the stack area size is larger than the remaining amount of the stack area (No in step S706), the application launch determining thread 142 determines that the application cannot be executed, and sends an application launch end request message to the application in step S709.

If the stack area size is no more than the remaining amount of the stack area (Yes in step S706), the application launch determining thread 142 determines that the stack area necessary for execution of the application can be kept. Next, the application launch determining thread 142 obtains current CPU operating ratio by issuing a system call in step S707. Then, the application launch determining thread 142 determines whether the CPU occupation time necessary for execution of the application is accepted for the CPU operating ratio in step S708. If the time is not accepted one (No in step S708), the application launch determining thread 142 determines that the system may become unstable if the application is executed, so that the thread 142 sends an application launch end request message to the application in step S709. For example, assuming that correspondence relationship between the CPU operating ratio and the CPU occupation time is determined such that the CPU occupation time should be no more than 60 ms if the CPU operating ratio is 50-60%, when current CPU operating ratio is 55% and the CPU occupation time is 80 ms, the application launch end request message is sent.

When the CPU occupation time is within the accepted time (Yes in step S708), for example, when the CPU operating ratio is 55% and the CPU occupation time is 40 ms, the thread 142 determines that the application operates stable. Next, the application launch determining thread 142 sends an application launch available notification message to the application in step S710.

When the application receives the application launch available notification message from the application launch determining thread 142, the application continues execution of processes. When the application receives the application launch end request message from the application launch determining thread 142, the application terminates the execution. The application that received the message may terminate its execution after the application releases resources kept so far in the apparatus.

When the application launch determining thread 142 determines that the launch of the application should be terminated, the application launch determining thread 142 may send a message to a control service such as the MCS125 for requesting to increase the text memory area, heap area or the stack area. Then, after the resources necessary for the application is kept, the thread 142 can send the launch available notification message to the application. In this case, compared with the case where the application launch end request is simply sent, the convenience of the user can be improved.

As mentioned above, according to the compound machine 100 of the first embodiment, the resource use information obtaining thread 141 in the VAS 140 obtains information on resources used by the application 130 so as to generate the resource use information file 201. When the application is launched, the application launch determining thread 142 obtains remaining amounts of the text memory area, the heap area, the stack area and the CPU operating ratio, and determines whether the application can be launched or not on the basis of the remaining resources and the information in the resource use information file 201. Thus, it can be avoided that the application cannot be launched due to lack of the resources, so that stability of the compound machine 100 can be improved. In addition, if the third vendor develops the new application 117, 118 without consideration of limit of the resources, it can be avoided that the system becomes unstable due to lack of the resources, so that stability of the compound machine 100 can be improved.

In the compound machine 100 of the first embodiment, the VAS 140 performs the processes for obtaining resource use information and determining application launch for all applications. However, as shown in FIG. 2, the compound machine can be also configured such that the VAS 140 can be provided only for a part of the applications. For example, the compound machine can be configured such that the processes for obtaining resource use information and determining application launch are performed only for the new applications 117, 118 that was developed by a third party, and such processes are not performed for the existing applications such as the printer application 111 and the copy application 112.

In the first embodiment, the usage of resources is stored in the resource use information file 201 when the application is launched for the first time and the resource use information file is used for launch determination for subsequent launches. In another example, the VAS refers to the proc structure at regular time intervals while the application is executed, such that the VAS obtains the usage of the resources a plurality of times for each resource. Then, the VAS obtains a mean value of the usage and stores the mean value in the resource use information file 201. In addition, the VAS 140 may store a maximum value in the plurality of obtained values in the resource use information file 201.

In addition, the VAS may obtains the mean value each time when the application is executed, and if the mean value exceeds a mean value of previous execution of the application, the VAS may store the mean value in the resource use information file 201 to update the resource use information file 201. In addition, the VAS may obtains the maximum value each time when the application is executed, and if the maximum value exceeds a maximum value of previous execution of the application, the VAS may store the maximum value in the resource use information file 201 to update the resource use information file 201.

In addition, the VAS may store the mean value in an area other than the resource use information file 201 each time when the application is executed, and the VAS may store a mean value of mean values stored in the area in the resource use information file 201. In addition, the VAS may store the maximum value in an area other than the resource use information file 201 each time when the application is executed, and the VAS may store a mean value or a maximum value of maximum values stored in the area in the resource use information file 201.

(Second Embodiment)

In the following, the second embodiment will be described. In the first embodiment, the VAS 140 determines whether the application can be launched or not. On the other hand, in the second embodiment, the application receives an evaluation message on resource amounts from the VAS 140, so that the application may determine whether the application can continue launch or not. In addition, not only the memory area and the CPU power but also system hardware configuration such as units connected to the compound machine can be used for determining launch of the compound machine.

The configuration of the second embodiment is the same as that shown in FIG. 1 or that shown in FIG. 2. In addition, the following processes performed by the VAS 140 can be performed by threads in the same way as the first embodiment, or can be performed by a process of the VAS 140.

In the first embodiment, the resource use information file that stores actual results of resource usage is used as a file to be referred to as resource usage that the application will use. On the other hand, according to the second embodiment, the resource use information file that stores actual results is used for usage of resources that dynamically changes such as CPU usage. As for resources that are used by the application fixedly such as predetermined memory areas, use resource information that is reported from the application is used. The use resource information is obtained from the application (from a memory area) by the VAS 140 when the application is launched for the first time, and is recorded in the hard disk as an application management file. The fixedly used resources are resources in which the usage by the application does not change or changes a little each time the application is executed.

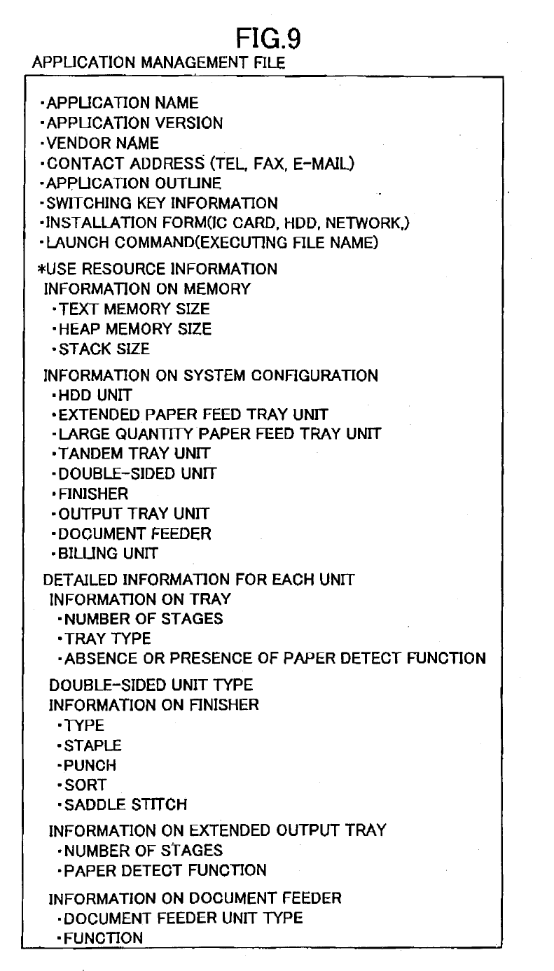

FIG. 9 shows an example of the application management file. As shown in the figure, the application management file includes information such as application name and the version, and use resource information including memory area and system configuration. In addition, the RAM (NV-RAM (nonvolatile RAM) in this embodiment) stores information indicating the location of the application management file in the HD 200.

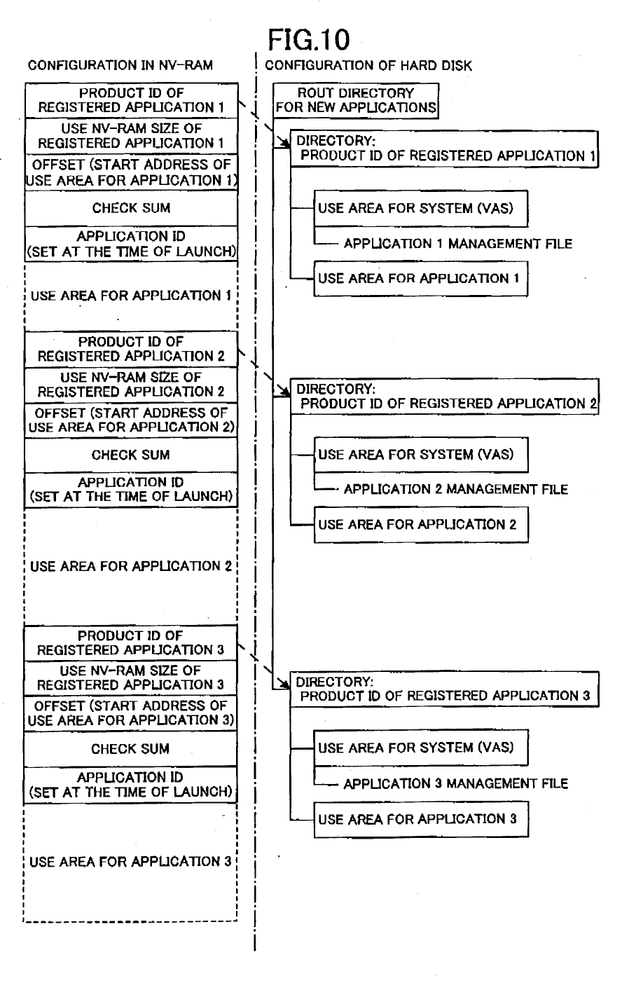

FIG. 10 shows a configuration example of the NV-RAM and the HD for new applications such as the applications 117 and 118.

As shown in the figure, the NV-RAM stores product ID of application, use NV-RAM size, offset that indicates start address of use area of the NV-RAM and the like for each new application that is registered. In addition, an area corresponding to the product ID is provided in the HD 200.

For example, for the application 1, a directory is provided in the HD 200 in which an area used by the system (VAS 140) and an area used by the application 1. The application management file shown in FIG. 9 is stored in the system use area.

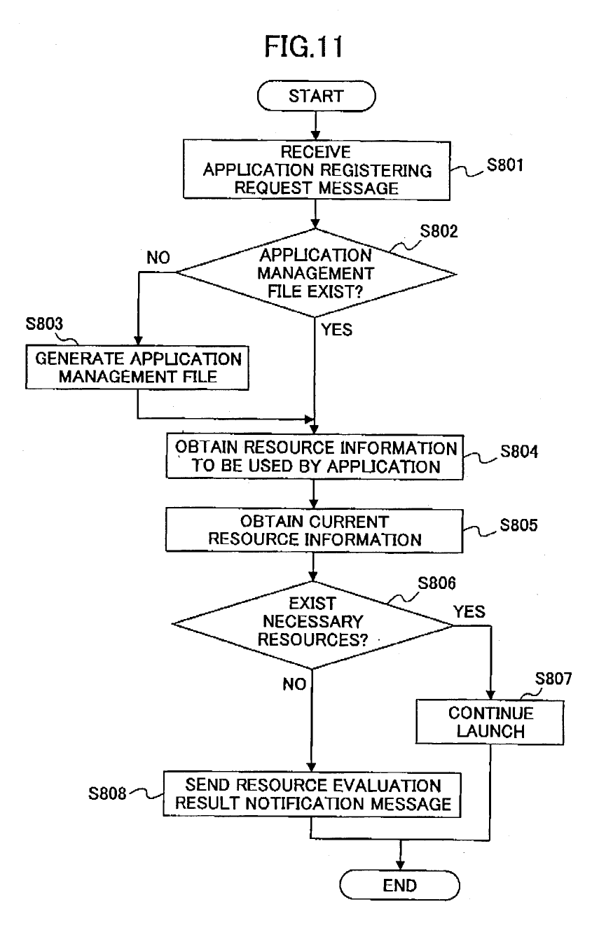

Next, processes performed by the VAS 140 at the time when the application is launched will be described with reference to a flowchart shown in FIG. 11.

In the same way as the first embodiment, when the application starts to be launched, the VAS 140 receives the application registering request message in step S801. Then, the VAS 140 checks whether there is an application management file corresponding to the application by accessing the HD 200 in step S802. If there is not the application management file, the application management file is generated by using information from the application in step S803. Whether the application management file exists or not can be also checked by accessing the NV-RAM.

If the application management file exists, the VAS 140 obtains resource information to be used by the application in step S804. Instead of using the application management file, resource information declared by the application can be used. As for CPU usage, a resource use information file is generated for CPU usage in the same way as the first embodiment, and the resource information on the CPU is obtained from the resource use information file. That is, as to the CPU usage, it is not used for launch determination for the first time launch of the application, and is used for launch determination for subsequent launches. The CPU usage may not be used for launch determination. Information in the resource use information file can be recorded in the application management file.

Next, the VAS 140 obtains current system resource information of the compound machine 100 in step S805. In addition, the VAS 140 obtains remaining capacity in the compound machine 100 as to memory area. Then, the VAS 140 checks whether there are enough resources to be used for the application in the compound machine in step S806. More particularly, as for resources of system hardware configuration, the VAS 140 checks whether the resource to be used by the application exists in the current system resource information. As for resources such as memory area, the VAS 140 compares the resource amount to be used by the application with the current resource amount.

When every resource amount to be used does not exceeds the corresponding current resource amount and when there is provided with necessary configuration resources (such as units), the launch of the application continues in step S807. On the other hand, when there is a resource in which the amount to be used is more than the corresponding current resource amount, or when there is a resource to be used by the application but not actually provided in the compound machine, the VAS 140 sends a resource evaluation result message to the application in step S808. The application determines whether the application continues execution of the application on the basis of the resource evaluation result message. As for resources for system configuration necessary for the application, the resource evaluation result message of this embodiment includes presence or absence (present—OK, absent—NG) of the resources for each resource. As for resources such as memory area, the resource evaluation result message of this embodiment includes OK if the resource amount to be used by the application is less than the amount of current corresponding resource, and NG if the resource amount to be used by the application exceeds the amount of current corresponding resource.

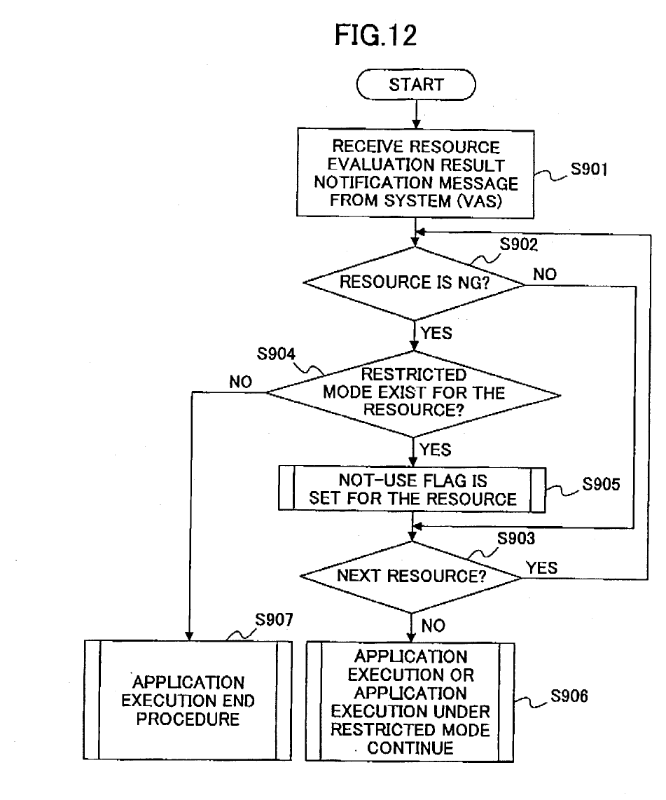

Next, operation of the application that receives the resource evaluation result message will be described with reference to FIG. 12.

When the application receives the resource evaluation result message in Step S901, the application checks whether the first resource included in the message is NG or not in step S902.

If it is not NG, the application checks whether next resource exists in step S903, and if there is the next resource, next resource is checked. If the first resource is NG in step S902, the application sets not-use flag for the resource when the application has a restricted operation mode for the resource (Yes in step S904, step S905). In the restricted mode, the application operates without a resource such as a unit in the system hardware configuration, or the application operates by reducing memory area to be used. In the example shown in FIG. 12, a resource is not used in the restricted operation mode.

In this case, the application may display that the resource is NG on the operation panel, so that the application inquires of the user whether operation under the restricted mode is accepted. Then, only when the user accepts the operation under the restricted mode, the application may continue the execution.

As to an evaluation result indicating that CPU power is not enough, this evaluation result may be displayed on the operation panel, and the application may inquire of the user whether slower operation is accepted by the user. Then, when the slower operation is accepted by the user, the application may continue the operation.

In step S903, if there is no further resource information in the message, the launch of the application continues, or the launch of the application under restriction continues in step S906.

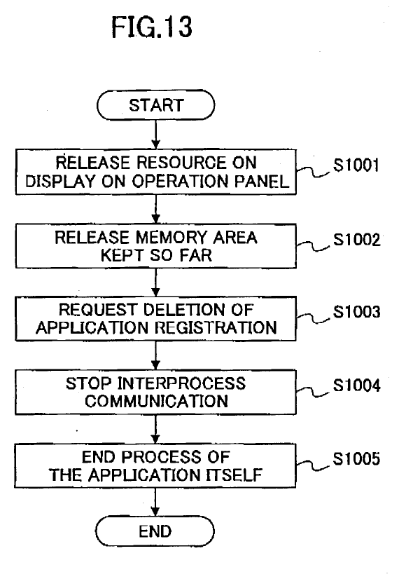

In step S904, if the application does not have the restricted operation mode, application launch termination procedure is performed in step S907. This procedure will be described with reference to FIG. 13.

First, resource for displaying data on the operation panel is released in step S1001. Then, memory area kept so far is released in step S1002, and the application sends an application registration delete request to the VAS in step S1003. Next, the application performs termination process of interprocess communication in step S1004, and ends its process by using a system call in step S1005. Before the above-mentioned procedure, notification to the user, release of scanner, plotter and network resources are performed as necessary.

In step S806 in FIG. 11, when an amount of a resource to be used exceeds the corresponding current resource amount and when the resource relates to the memory area (text memory area, heap area, stack area) used by the application fixedly, the VAS 140 may determine that the application can not be launched, so that the VAS 140 sends a launch end request to the application. In this case, the application immediately executes the procedure shown in FIG. 13. In addition, the VAS 140 may determine whether the application operates under restriction mode. When the VAS 140 determines that the application can operate under the restriction mode, the VAS 140 may send a message for operating under the restriction mode to the application. In this case, the VAS 140 may inquire of the user whether the user accepts the operation under restriction mode.

As mentioned above, by using the system configuration information as the resource information such as shown in FIG. 9 as information on configuration, for example, useless launch of an application can be avoided. More particularly, it can be avoided to launch an application when the compound machine 100 is not provided with a device necessary for using the application, in which the application can not be used without the device, for example, device for punch, staple and the like.

In addition to the system configuration, model information can be used. Accordingly. malfunction due to difference between a model targeted for the application and actual model can be avoided.

In the flow shown in FIG. 11, instead of obtaining information of resources to be used by the application and comparing resources to be used with actual resources, the VAS 140 may send actual current system configuration information and remaining resources to the application as the resource evaluation result message, so that the application can determine whether there are enough necessary resources. In this case, the application compares resources to be used by the application (that is held by the application itself) and the resources included in the message on by one, so that the application determines it can continue to launch.

The process shown in FIG. 11 may be performed every time when the application is launched or only when the application is installed.

Next, the procedure performed by the VAS 140 for obtaining the current resource information in step S805 in FIG. 11 will be described.

In this procedure, the VAS 140 obtains information on system configuration and system resource amounts such as memory area and the like. Before describing the procedure for step S805, the process for obtaining the system configuration information will be described.

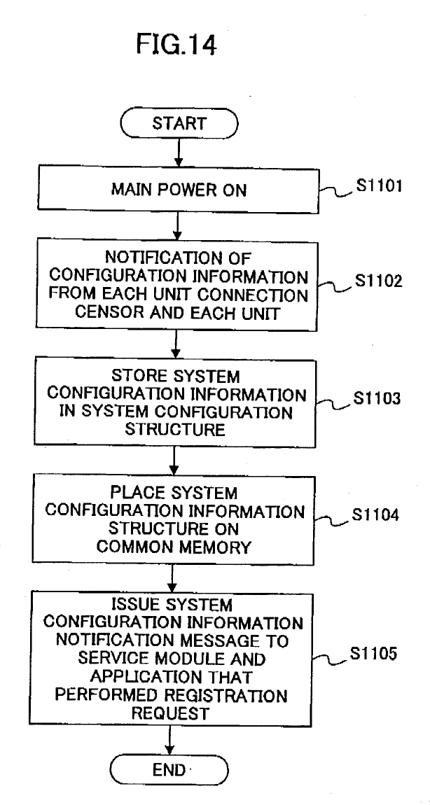

The system configuration information is obtained by a service module in the control service layer (for example, SCS 11, hereinafter the case where SCS 122 obtains the information will be described). Then, SCS 122 stores the obtained system configuration information in a system configuration information structure. In the following, this procedure will be described with reference to FIG. 14.

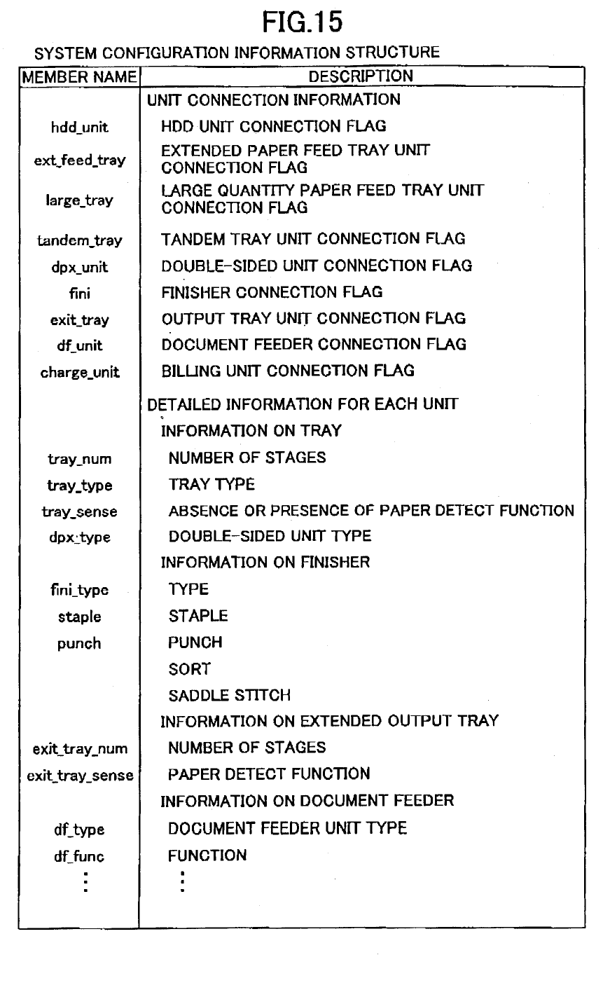

When the main power of the compound machine is turned on in step S1101, the SCS 122 receives notification of configuration information from each unit connecting censor and from each unit in step S1102. The SCS 122 stores the configuration information in the system configuration information structure in step S1103. FIG. 15 shows an example of the system configuration information structure. That is, the SCS 122 obtains information shown in FIG. 15 and stores the information in the system configuration information structure.

After that, the system configuration information structure is placed on a common memory (that is RAM physically) in step S1104, and the SCS 122 sends a system configuration information notification message to each service module and application that has sent registration request to SCS 122 in step S1105. For example, when the VAS 140 is launched, the system configuration information notification message is sent to the VAS 140 from the SCS 122.

According to the above-mentioned procedure, the system configuration information structure is placed on the common memory so that the modules (such as the VAS) can obtain the system configuration information by accessing the system configuration structure.

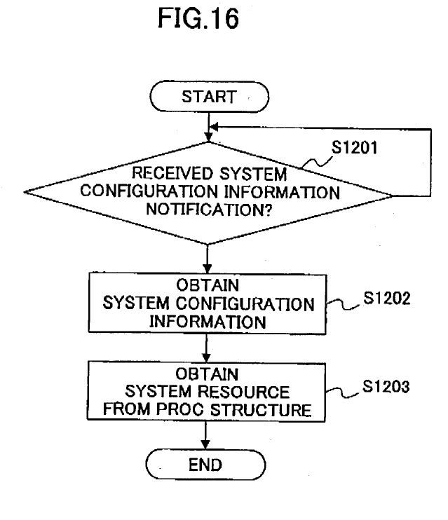

Next, the procedure for obtaining current resource information by the VAS 140 in step 5805 in FIG. 11 will be described by referring to FIG. 16.

First, the VAS 140 checks whether it already has received the system configuration information notification message in step S1201. If the VAS 140 has not received the system configuration information notification message, the VAS 140 repeats the check whether received the message at predetermined time intervals. If the VAS 140 does not receive the system configuration information notification message, system error occurs upon time-out.

If the VAS 140 has received the system configuration information notification message, the VAS 140 obtains the system configuration information by accessing the system configuration information structure in step S1202. After that, the VAS 140 obtains system resource usage by accessing the proc structure in step S1203.

Accordingly, it becomes possible to obtain the current system resources used for comparing with the resources to be used by the application.

(Third Embodiment)

In the first and second embodiment, the current resource usage is obtained from the proc structure. On the other hand, according to the third embodiment, current resource usage is not obtained, instead, resources are allocated to new applications beforehand. The determination for launch is performed by comparing the allocated resource amounts and resource amounts to be used by the new applications. The resource amounts that are allocated beforehand can be stored in the application management file, for example.

For example, instead of obtaining current resource usage in the flowchart of FIG. 8 in the first embodiment, resources allocated beforehand are obtained from, for example, the application management file, determination for launch is performed by comparing the obtained resources with resources to be used by the application.

When a plurality of new applications are launched, a resource amount may be allocated to the plurality of new applications as a whole, or a resource amount may be allocated to each of the new applications.

In the case where the resource amount is allocated to the plurality of new applications as a whole, when a new application is launched, a resource amount to be used for the new application is subtracted from the allocated resource amount. when next new application is launched, a resource amount to be used for the next new application is compared with the resource amount in which the resource amount of the previous application has been subtracted from the allocated resource amount, so that determination for launch is performed. The same process is performed for applications launched hereinafter.

In the case where a resource amount may be allocated to each of the new applications, for example, a resource amount to be used by a new application is checked and the amount is allocated as the resource amount to be allocated beforehand. In addition, the resources may be allocated equally for the plurality of new applications.

The above-mentioned method is effective for resources necessary for the applications fixedly such as memory area As to CPU power that cannot be allocated beforehand, it may not be used for determination of launch, or used by using the methods of the first or second embodiments.

(Fourth Embodiment)

According to the compound machine 100 of the first embodiment, the VAS 140 is provided for all of the applications. According to this fourth embodiment, one VAS is provided for each application, each VAS performs obtaining of resource use information and performs application launch determination for one application. In this fourth embodiment, although the operation of a VAS is similar to that of the first embodiment, the operation of the second and third embodiments can be also applied to this fourth embodiment.

FIG. 17 is a block diagram showing a configuration of the compound machine 800 of the fourth embodiment. As shown in FIG. 17, the compound machine 800 is different from the compound machine 100 of the first embodiment in that a plurality of virtual application services 841-848 operate for each application in the compound machine 800.

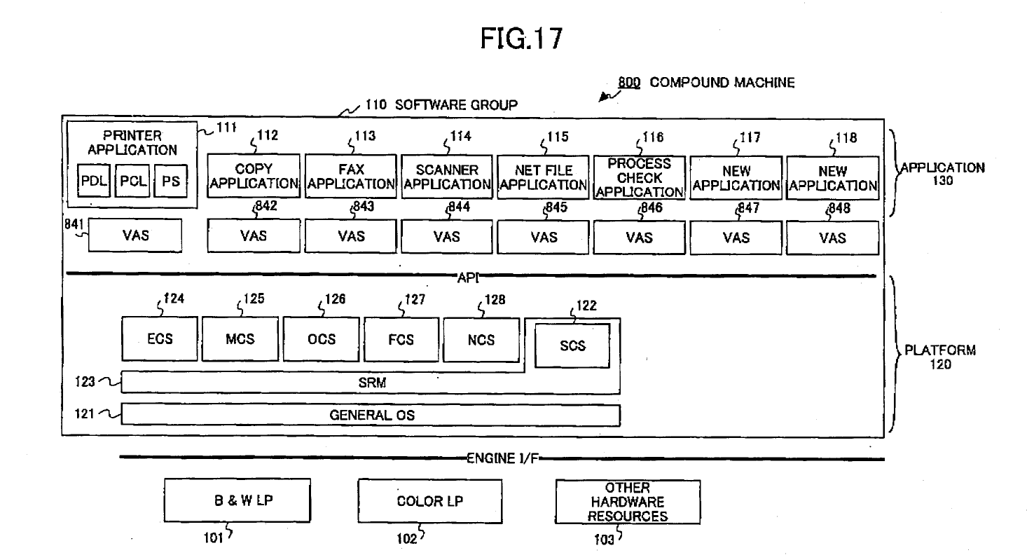

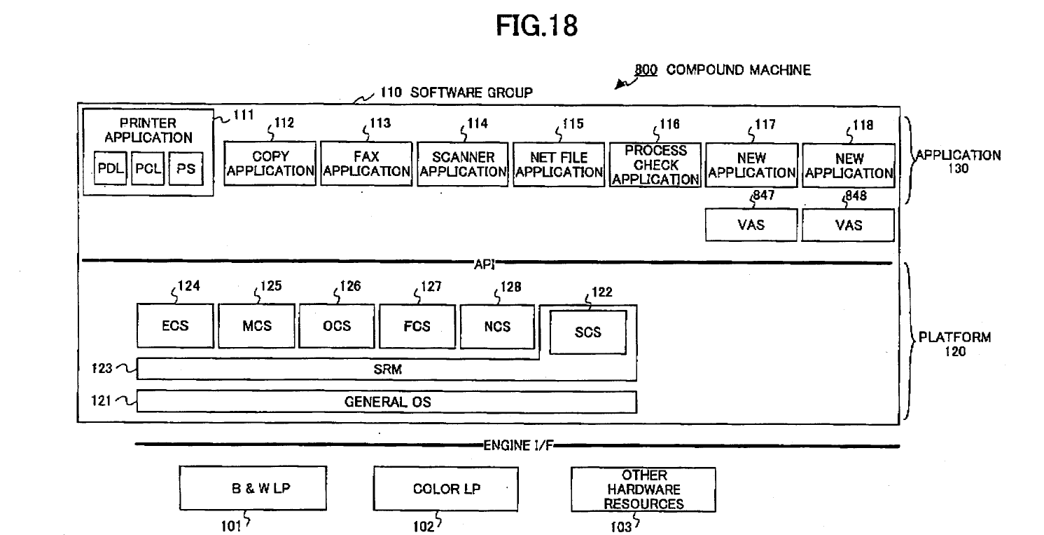

The VASes 841-848 obtain resource use information and perform application launch determining processes for the printer application 111, the copy application 112, the fax application 113, the scanner application 114, the net file application 115, the process check application 116 and the new applications 117 and 118. The compound machine 800 can be also configured as shown in FIG. 18 in which the VASes are provided only for the new applications.

FIG. 19 shows the configuration of the VASes 841-848 of the compound machine 800 and relationships between VASes 841-848 and applications and the control service layer 150 and the general OS 121. In FIG. 17, the printer application 111, the copy application 112 and the new applications 117 and 118 are shown, and the corresponding VASes 841, 842, 847 and 848 are shown as an example. As for other applications, same configuration can be taken.

As shown in FIG. 19, different from the compound machine 100 according to the first embodiment, a VAS control process 801 (daemon) operates between each VAS and each application in the compound machine 800 of the fourth embodiment.

The VAS control process 801 performs application registering processes by receiving an application registering request message from an application and generates a VAS corresponding to the application from which the application registering request is received. In addition, the VAS control process 801 checks whether resource use information is stored for the application that sent the application registering request by referring to the resource use information file 201 stored in the HD 200, so as to determine whether the launch of the application is the first launch or the second or more. If the launch is the first time, the control process 801 sends a request for obtaining resource use information with an application ID and the process ID of the application to the VAS corresponding to the application. If the launch is the second time or more, the control process 801 sends an application launch determining process request with the application ID and the process ID of the application to the VAS.

In the process of the VAS, a dispatcher 144, a resource use information obtaining thread 141, and an application launch determining thread 142 operate.

The dispatcher 144 monitors message reception from the applications and the control services, and sends a process request to the resource use information obtaining thread 141 and the application launch determining thread 142 according to the message. In the compound machine 800 of the fourth embodiment, the dispatcher 144 receives the resource use information obtaining request message or the application launch determining request message from the VAS control process 801 with the application ID and the process ID of the application. When the dispatcher 144 receives the resource use information obtaining request message, the dispatcher 144 sends it to the thread 141. When the dispatcher 144 receives the application launch determining request message, the dispatcher sends it to the thread 142.

When the resource use information obtaining thread 141 receives the resource use information obtaining request message from the dispatcher 144, the thread obtains resource information necessary for launching the application and generates the resource use information file 201 in the hard disk (HD) 200.

When the application launch determining thread 142 receives the application launch determining request message from the dispatcher 144, the thread 142 determines whether the application can be launched by referring to the resource use information file 201.

The resource use information obtaining thread 141 performs the same processes as those in the first embodiment, and the application launch determining thread 142 performs the same processes as those in the first embodiment.

In the same way as the first embodiment, according to the fourth embodiment, stability of the compound machine 800 can be improved.

In addition, according to the compound machine 800 in the fourth embodiment, since a VAS is launched for each application, the launch determination can be performed in parallel by a plurality of VASes for a plurality of applications, so that the determination can be performed efficiently.

Although the VAS is launched for each application. for all applications, the VASes can be launched for a part of the applications as shown in FIG. 18. For example, the VASes may be provided only for the new applications 117, 118 developed by a third vendor and the like.

In the compound machined 100 and 800 in the first and fourth embodiment, the application launch determination is performed by using resource information on text memory area, heap area, stack area, CPU occupation time, CPU operating ratio. However, these items are merely examples and other resources can be also used for the determination.

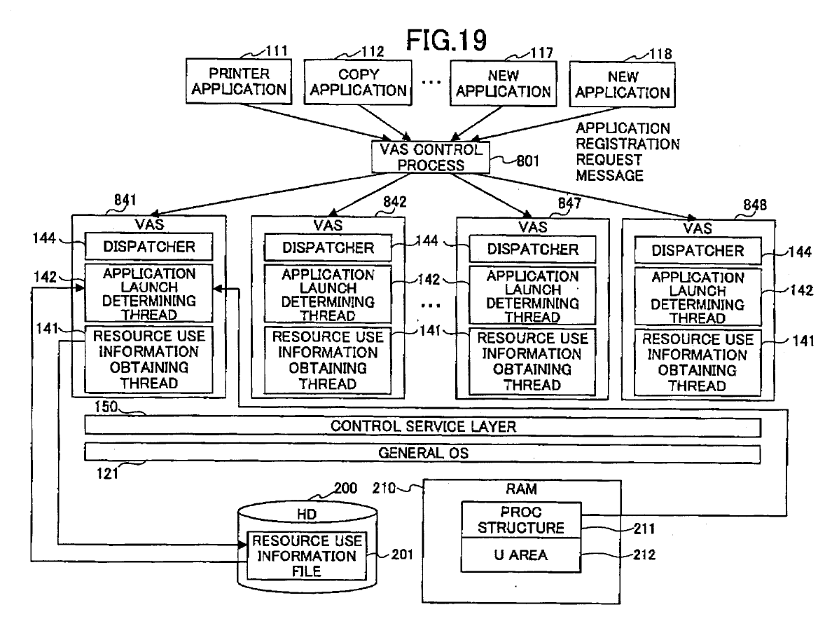

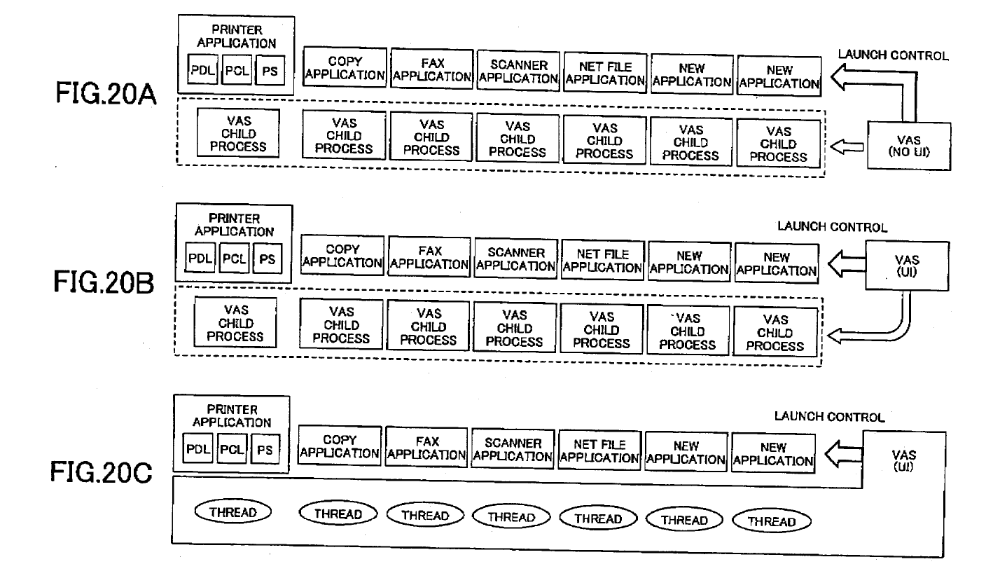

As a configuration of the VAS, configurations shown in FIGS. 20A-20C can be also adopted. FIG. 20A shows a case in which child processes of a parent VAS is used for each application, in which the parent VAS does not have screen control right (does not have user interface). FIG. 20B shows a case in which the parent VAS has the screen control right. FIG. 20C shows a case in which the functions of VAS are provided by using threads for each application.

As mentioned above, according to the present invention, an apparatus is provided in which the apparatus includes:

a part for obtaining resource status information indicating status of resources of the apparatus when the application is launched; and

a part for sending a message on launch determination to the application by referring to the resource status information and resource use information on resources to be used by the application.

According to this invention, since the message is sent to the application on the basis of the resource status information and the resource use information, the application can determines whether to continue launch of the application. Therefore, problems that may occur if the application is executed while a resource used by the application lacks can be avoided, so that stability of the apparatus can be improved.

The apparatus may further includes a resource use information obtaining part for obtaining information on the resources used by the application and generating the resource use information. According to this invention, for example, the resource use information obtaining part can obtain actual data of resource usage.

In the apparatus, the resource use information obtaining part obtains information on the resources used by the application and generates the resource use information when the application is launched for the first time.

According to this invention, the resource use information can be used for determining availability of launch when the application is launched second time or later.

The resource use information obtaining part may obtain usage of the resources used by the application at predetermined time intervals while the application is executed, and generates the resource use information on the basis of the usage, and stores the resource use information.

According to this invention, since the resource use information is generated on the basis of the usage data obtained at predetermined time intervals, accurate resource use information can be obtained.

In addition, the resource use information obtaining part may obtain the information on the resources used by the application from system information on resources used by a process in the apparatus, and generates the resource use information.

The apparatus may further includes a resource use information obtaining part for obtaining the information on the resources to be used by the application from the application and generates the resource use information.

According to this invention, since information on resources declared by the application can be used, various information can be used for determination of launch.

In the apparatus, the information on the resources may include configuration information of the apparatus. Accordingly, the configuration information can be used for determination of launch.

The resource use information obtaining part may:

obtain information on resources from the application as to resources used by the application fixedly;

obtain usage of resources used by the application from system information as to resources in which the usage may be changed each time the application is executed. Accordingly, the resource use information can be obtained efficiently.

The apparatus may send a message, to the application, indicating that the application cannot be executed when the apparatus determines that a resource lacks for executing the application on the basis of the resource status information and the resource use information.

In addition, the message may include information indicating whether there are enough resources for executing the application, and the application determines whether to continue execution on the basis of the received message.

According to the above invention, problems that occur if the application is executed even though necessary resource lacks can be avoided.

The apparatus may use resource amounts that are assigned to the application beforehand as the resource status information.

The apparatus may be an embedded apparatus that provides services by using embedded software, and

the application is an application installed in the apparatus separately from the embedded software. According to this invention, launch determination can be performed when an application is added to an embedded apparatus.

In addition, the apparatus may be an image forming apparatus, the image forming apparatus comprising.

hardware resources used for image forming processes;

a control service part for providing services on control of the hardware resources commonly to a plurality of applications; and

a virtual application service part that operates as a client process for the control service part as a server, and operates as a server process for the application as a client,

wherein the virtual application service part includes the part for sending the message.

According to this invention, launch determination can be performed when an application is added to an image forming apparatus.

According to the present invention, a computer program for causing an apparatus that generates a message including information on resources to execute processes according to the message is provided, the computer program includes:

program code means for receiving the message;

program code means for releasing resources kept by the computer program in the apparatus and ending execution of the computer program when the message indicating that the computer program cannot be executed in the apparatus.

Another computer program includes:

program code means for receiving the message;

program code means for determining whether to continue execution of the computer program or stop execution according to information on resources included in the message.

The computer program may further includes:

program code means for continuing execution of the computer program under a restricted mode in which a resources is not used when the message includes information indicating that the resource is not enough for executing the computer program.

In addition, the computer program may further includes:

program code means for inquiring of the user whether execution under the restricted mode is accepted via an operation part of the apparatus;

wherein execution of the computer program is continued when execution under the restricted mode is accepted.

According to the present invention, another apparatus including resources used for executing an application is provided, the apparatus includes:

an obtaining part for obtaining resource information on resources used by the application while the application is executed, and storing the resource information in a storage.

According to this invention, for example, accurate information for launch determination for the application can be obtained.

In the apparatus, the obtaining part may obtain usage of resources used by the application at predetermined time intervals, generates the resource information from the obtained usage, and stores the resource information.

The resource information may be a mean value or a maximum value in usage data obtained at predetermined time intervals.

In addition, the apparatus may obtain the mean values or the maximum values for each of time periods from launch to the end of execution of the application; and

store a mean value or a maximum value of the mean values for each of the time periods as the resource information, or a mean value or a maximum value of the maximum values for each of the time periods as the resource information.

According to the above invention, since a plurality of values obtained at time intervals, proper usage can be obtained compared with a case where the usage is obtained only once.

The obtaining part may obtain the information on the resources used by the application from system information on resources used by a process in the apparatus, and generate the resource information. Accordingly, the resource information can be obtained efficiently.

According the present invention, another apparatus including resources used for executing an application is provided, the apparatus includes:

a part for receiving configuration information from resources of hardware mounted in the apparatus, and storing the configuration information in a storage.

According to this invention, configuration information of the apparatus can be obtained.

The apparatus may further includes:

a part for sending a message to a software module executed in the apparatus, the message indicating that the configuration message is obtained.

According to this invention, the software module can recognize that the configuration information is obtained, so that the software module can obtain the configuration information by accessing the storage.

Another apparatus can be provided, the apparatus includes:

an application management file including information on resources to be used by the application;

an obtaining part for obtaining information on resources to be used by the application from the application management file when the application is launched.

According to this invention, information on resources can be obtained only be accessing the application management file.

The application management file may include information on memory area and information on configuration of the apparatus. Accordingly, information on memory area and information on configuration of the apparatus can be obtained only be accessing the application management file.

The apparatus may further include an application management file including information on resources to be used by the application,

wherein the apparatus obtains information on resources fixedly used by the application from the application management file as the resource information when the application is launched, According to this invention, resource information fixedly used by the application can be obtained efficiently.

The information on resources in the application management file may be obtained from the application when the application is launched.

As mentioned above, according to the present invention, information on resources used by an application can be obtained. Thus, by obtaining the information on the resources, it can be determined whether an application can be launched based on the information on the resources.

The present invention is not limited to the specifically disclosed embodiments and variations and modifications may be made without departing from the scope of the present invention.

What is claimed is:

1. An apparatus including resources used for executing an application, the apparatus comprising:
a part for obtaining resource status information indicating status of resources of the apparatus when the application is launched; and
a part for sending a message on launch determination to the application by referring to the resource status information and resource use information on resources to be used by the application.

2. The apparatus as claimed in claim 1, the application further comprising a resource use information obtaining part for obtaining information on the resources used by the application and generating the resource use information.

3. The apparatus as claimed in claim 2, wherein the resource use information obtaining part obtains information on the resources used by the application and generates the resource use information when the application is launched for the first time.

4. The apparatus as claimed in claim 2, wherein the resource use information obtaining part obtains usage of the resources used by the application at predetermined time intervals while the application is executed, and generates the resource use information on the basis of the usage, and stores the resource use information.

5. The apparatus as claimed in claim 2, wherein the resource use information obtaining part obtains the information on the resources used by the application from system information on resources used by a process in the apparatus, and generates the resource use information.

6. The apparatus as claimed in claim 1, the apparatus further comprising a resource use information obtaining part for obtaining the information on the resources to be used by the application from the application and generates the resource use information.

7. The apparatus as claimed in claim 6, wherein the information on the resources includes configuration information of the apparatus.

8. The apparatus as claimed in claim 2, wherein the resource use information obtaining part:
obtains information on resources from the application as to resources used by the application fixedly;
obtains usage of resources used by the application from system information as to resources in which the usage may be changed each time the application is executed.

9. The apparatus as claimed in claim 1, wherein the apparatus sends a message, to the application, indicating that the application cannot be executed when the apparatus determines that a resource lacks for executing the application on the basis of the resource status information and the resource use information.

10. The apparatus as claimed in claim 1, wherein the message includes information indicating whether there are enough resources for executing the application, and the application determines whether to continue execution on the basis of the received message.

11. The apparatus as claimed in claim 1, wherein the apparatus uses resource amounts that are assigned to the application beforehand as the resource status information.

12. The apparatus as claimed in claim 1, wherein the apparatus is an embedded apparatus that provides services by using embedded software, and
the application is an application installed in the apparatus separately from the embedded software.

13. The apparatus as claimed in claim 12, wherein the apparatus is an image forming apparatus, the image forming apparatus comprising:
hardware resources used for image forming processes;
a control service part for providing services on control of the hardware resources commonly to a plurality of applications; and
a virtual application service part that operates as a client process for the control service part as a server, and operates as a server process for the application as a client,
wherein the virtual application service part includes the part for sending the message.

14. A computer program for causing an apparatus that generates a message including information on resources to execute processes according to the message, the computer program comprising:
program code means for receiving the message;
program code means for releasing resources kept by the computer program in the apparatus and ending execution of the computer program when the message indicating that the computer program cannot be executed in the apparatus.

15. A computer program for causing an apparatus that generates a message including information on resources to execute processes according to the message, the computer program comprising:
program code means for receiving the message;
program code means for determining whether to continue execution of the computer program or stop execution according to information on resources included in the message.

16. The computer program as claimed in claim 15, the computer program further comprising:
program code means for continuing execution of the computer program under a restricted mode in which a resources is not used when the message includes information indicating that the resource is not enough for executing the computer program.

17. The computer program as claimed in claim 16, the computer program further comprising:
program code means for inquiring of the user whether execution under the restricted mode is accepted via an operation part of the apparatus;
wherein execution of the computer program is continued when execution under the restricted mode is accepted.

18. The computer program as claimed in claim 15, the computer program further comprising:
program code means for releasing resources kept by the computer program in the apparatus and ending execution of the computer program when the message includes information indicating that a resource is not enough for executing the computer program.

19. A computer readable medium storing program code for causing an apparatus that generates a message including information on resources to execute processes according to the message, the computer readable medium comprising:
program code means for receiving the message;
program code means for determining whether to continue execution of the computer program or stop execution according to information on resources included in the message.

20. A method used in an apparatus including resources used for executing an application, the method comprising the steps of:
obtaining resource status information indicating status of resources of the apparatus when the application is launched; and
sending a message on launch determination to the application by referring to the resource status information and resource use information on resources to be used by the application.

21. The method as claimed in claim 20, the method further comprising a resource use information obtaining step for obtaining information on the resources used by the application and generating the resource use information.

22. The method as claimed in claim 21, wherein the apparatus obtains information on the resources used by the application and generates the resource use information when the application is launched for the first time.

23. The method as claimed in claim 21, wherein the apparatus obtains usage of the resources used by the application at predetermined time intervals while the application is executed, and generates the resource use information on the basis of the usage, and stores the resource use information.

24. The method as claimed in claim 21, wherein the apparatus obtains the information on the resources used by the application from system information on resources used by a process in the apparatus, and generates the resource use information.

25. The method as claimed in claim 20, the method further comprising a resource use information obtaining step for obtaining the information on the resources to be used by the application from the application and generates the resource use information.

26. The method as claimed in claim 25, wherein the information on the resources includes configuration information of the apparatus.

27. The method as claimed in claim 21, wherein, in the resource use information obtaining step, the apparatus:
obtains information on resources from the application as to resources used by the application fixedly;
obtains usage of resources used by the application from system information as to resources in which the usage may be changed each time the application is executed.

28. The method as claimed in claim 20, wherein the apparatus sends a message, to the application, indicating that the application cannot be executed when the apparatus determines that a resource lacks for executing the application on the basis of the resource status information and the resource use information.

29. The method as claimed in claim 20, wherein the message includes information indicating whether there are enough resources for executing the application, and the application determines whether to continue execution on the basis of the received message.

30. The method as claimed in claim 20, wherein the apparatus uses resource amounts that are assigned to the application beforehand as the resource status information.

31. The method as claimed in claim 20, wherein the apparatus is an embedded apparatus that provides services by using embedded software, and
the application is an application installed in the apparatus separately from the embedded software.

32. The method as claimed in claim 31, wherein the apparatus is an image forming apparatus, the image forming apparatus comprising:
hardware resources used for image forming processes;
a control service part for providing services on control of the hardware resources commonly to a plurality of applications; and
a virtual application service part that operates as a client process for the control service part as a server, and operates as a server process for the application as a client,
wherein the virtual application service sends the message.

33. An apparatus including resources used for executing an application, the apparatus comprising:
an obtaining part for obtaining resource information on resources used by the application while the application is executed, and storing the resource information in a storage.

34. The apparatus as claimed in claim 33, wherein the obtaining part obtains usage of resources used by the application at predetermined time intervals, generates the resource information from the obtained usage, and stores the resource information.

35. The apparatus as claimed in claim 34, wherein the resource information is a mean value or a maximum value in usage data obtained at predetermined time intervals.

36. The apparatus as claimed in claim 35, wherein the apparatus obtains the mean values or the maximum values for each of time periods from launch to the end of execution of the application; and
stores a mean value or a maximum value of the mean values for each of the time periods as the resource information, or a mean value or a maximum value of the maximum values for each of the time periods as the resource information.

37. The apparatus as claimed in claim 33, wherein the obtaining part obtains the information on the resources used by the application from system information on resources used by a process in the apparatus, and generates the resource information.

38. The apparatus as claimed in claim 33, wherein the apparatus is an embedded apparatus that provides services by using embedded software, and
the application is an application installed in the apparatus separately from the embedded software.

39. The apparatus as claimed in claim 38, wherein the apparatus is an image forming apparatus, the image forming apparatus comprising:
hardware resources used for image forming processes;
a control service part for providing services on control of the hardware resources commonly to a plurality of applications; and
a virtual application service part that operates as a client process for the control service part as a server, and operates as a server process for the application as a client,
wherein the virtual application service part includes the obtaining part.

40. An apparatus including resources used for executing an application, the apparatus comprising:
a part for receiving configuration information from resources of hardware mounted in the apparatus, and storing the configuration information in a storage.

41. The apparatus as claimed in claim 40, the apparatus further comprising:
a part for sending a message to a software module executed in the apparatus, the message indicating that the configuration message is obtained.

42. An apparatus including resources used for executing an application, the apparatus comprising:
an application management file including information on resources to be used by the application;
an obtaining part for obtaining information on resources to be used by the application from the application management file when the application is launched.

43. The apparatus as claimed in claim 42, wherein the application management file includes information on memory area and information on configuration of the apparatus.

44. The apparatus as claimed in claim 33, the apparatus further comprising an application management file including information on resources to be used by the application,
wherein the apparatus obtains information on resources fixedly used by the application from the application management file as the resource information when the application is launched.

45. The apparatus as claimed in claim 42, wherein the information on resources in the application management file is obtained from the application when the application is launched.

46. The apparatus as claimed in claim 42, wherein the apparatus is an embedded apparatus that provides services by using embedded software, and
the application is an application installed in the apparatus separately from the embedded software.

47. The apparatus as claimed in claim 46, wherein the apparatus is an image forming apparatus, the image forming apparatus comprising:
hardware resources used for image forming processes;
a control service part for providing services on control of the hardware resources commonly to a plurality of applications; and
a virtual application service part that operates as a client process for the control service part as a server, and operates as a server process for the application as a client,
wherein the virtual application service part includes the obtaining part.

48. A method used in an apparatus including resources used for executing an application, the apparatus comprising:
an obtaining step for obtaining resource information on resources used by the application while the application is executed, and storing the resource information in a storage.

49. The method as claimed in claim 48, wherein the obtaining part obtains usage of resources used by the application at predetermined time intervals, generates the resource information from the obtained usage, and stores the resource information.

50. The method as claimed in claim 49, wherein the resource information is a mean value or a maximum value in usage data obtained at predetermined time intervals.

51. The method as claimed in claim 50, wherein the apparatus obtains the mean values or the maximum values for each of time periods from launch to the end of execution of the application; and
stores a mean value or a maximum value of the mean values for each of the time periods as the resource information, or a mean value or a maximum value of the maximum values for each of the time periods as the resource information.

52. The method as claimed in claim 48, wherein, in the obtaining step, the apparatus obtains the information on the resources used by the application from system information on resources used by a process in the apparatus, and generates the resource information.

53. The method as claimed in claim 48, wherein the apparatus is an embedded apparatus that provides services by using embedded software, and
the application is an application installed in the apparatus separately from the embedded software.

54. The method as claimed in claim 53, wherein the apparatus is an image forming apparatus, the image forming apparatus comprising:
hardware resources used for image forming processes;
a control service part for providing services on control of the hardware resources commonly to a plurality of applications; and
a virtual application service part that operates as a client process for the control service part as a server, and operates as a server process for the application as a client,
wherein the virtual application service part performs the obtaining step.

55. A method used in an apparatus including resources used for executing an application, the apparatus comprising the step of:
receiving configuration information from resources of hardware mounted in the apparatus, and storing the configuration information in a storage.

56. The method as claimed in claim 55, the method further comprising the step of:
sending a message to a software module executed in the apparatus, the message indicating that the configuration message is obtained.

57. A method used in an apparatus including resources used for executing an application, the apparatus comprising an application management file including information on resources to be used by the application, the method comprising;
an obtaining step for obtaining information on resources to be used by the application from the application management file when the application is launched.

58. The method as claimed in claim 57, wherein the application management file includes information on memory area and information on configuration of the apparatus.

59. The method as claimed in claim 48, the apparatus further comprising an application management file including information on resources to be used by the application,
wherein the apparatus obtains information on resources fixedly used by the application from the application management file as the resource information when the application is launched.

60. The method as claimed in claim 57, wherein the information on resources in the application management file is obtained from the application when the application is launched.

61. The method as claimed in claim 57, wherein the apparatus is an embedded apparatus that provides services by using embedded software, and
the application is an application installed in the apparatus separately from the embedded software.

62. The method as claimed in claim 61, wherein the apparatus is an image forming apparatus, the image forming apparatus comprising:
hardware resources used for image forming processes;
a control service part for providing services on control of the hardware resources commonly to a plurality of applications; and
a virtual application service part that operates as a client process for the control service part as a server, and operates as a server process for the application as a client,
wherein the virtual application service part performs the obtaining step.
